(19) United States
(12) Patent Application Publication
(10) Pub. No.: US 2023/0271177 A1
(43) Pub. Date: Aug. 31, 2023

(54) LATERAL FLOW DEVICE

(71) Applicant: MOLOGIC LTD, Bedfordshire (GB)

(72) Inventors: Christopher DUNSTON, Thurleigh (GB); Adrian Walker, Thurleigh (GB)

(21) Appl. No.: 18/015,797

(22) PCT Filed: Jul. 15, 2021
(86) PCT No.: PCT/EP2021/069803

§ 371 Date: Jan. 12, 2023

(30) Foreign Application Priority Data
Jul. 15, 2020 (GB) 2010879.1

(51) Int. Cl. B01L 3/00

(52) U.S. Cl. CPC B01L 3/5023; B01L 2300/0672; B01L 2300/0825; B01L 2300/0864

(57) ABSTRACT

A lateral flow device for analysing a sample of liquid has a first lateral flow strip configured to respond to a first volume of sample and a second lateral flow strip configured to respond to a second volume of the sample, wherein the second volume is greater than the first volume. The lateral flow device comprises a first well configured to receive the first volume of the sample and a second well configured to receive the second volume of the sample. Each well has a flow restriction outlet located adjacent its lateral flow strip. The lateral flow device comprises a pre-actuation configuration and an actuated configuration. The first and second flow restriction outlets are configured such that, in use, in the pre-actuation configuration, a first surface tension of the first volume of the sample within the first well prevents the first volume of the sample passing through the first flow restriction outlet and a second surface tension of the second volume of the sample within the second well prevents the second volume of the sample passing through the second flow restriction outlet. In the actuated configuration, (a) the first flow restriction outlet is located sufficiently proximate the first lateral flow strip such that the first volume of the sample makes contact with the first lateral flow strip and is drawn along the first lateral flow strip thereby overcoming the first surface tension; and (b) the second flow restriction outlet is located sufficiently proximate the second lateral flow strip such that the second volume of the sample makes contact with the second lateral flow strip and is drawn along the second lateral flow strip thereby overcoming the second surface tension.

### TECHNICAL FIELD

The disclosure relates to a lateral flow device for performing an assay.

### BACKGROUND

Lateral flow devices are commonly used to provide a self-contained device for conducting an assay. Generally speaking, a sample to be tested is deposited on a receiving portion of an absorbent lateral flow strip. The sample may be liquid or solid. If the sample is liquid, it may itself be drawn along the lateral flow strip towards one or more test regions. A buffer solution may be provided either to dilute a liquid sample or to dissolve a solid sample in order that the sample and buffer may be drawn along the lateral flow strip towards the one or more test regions.

It is known to provide a plurality of lateral flow strips in parallel in a single lateral flow device. This may be in order to accommodate more test regions than could be accommodated on a single lateral flow strip. Or it may be to accommodate analysis of more than one sample on a single device.

Reliability of an assay may be dependent upon having an appropriate quantity of the sample to be analysed. For example, where there is insufficient sample (perhaps even after dilution in a buffer solution), it may be that no sample solution (or at least insufficient sample solution) may reach the test strip(s). Or, where there is too much sample (whether with or without buffer solution) a lateral flow strip may become flooded.

Therefore, ensuring an appropriate quantity of the sample arriving at the lateral flow strip may be critical to accuracy of the assay.

This issue may be complicated further in an event that a lateral flow device comprises a plurality of test strips.

### SUMMARY OF THE DISCLOSURE

Against this background, in a first aspect of the disclosure, there is provided: a lateral flow device for analysing a sample of liquid, the lateral flow device comprising:
a sample receiving zone for receiving the sample to be analysed;
a first lateral flow strip configured to respond to a first volume of the sample;
a second lateral flow strip configured to respond to a second volume of the sample, wherein the second volume is greater than the first volume;
a first well configured to receive the first volume of the sample from the sample receiving zone, the first well comprising a first flow restriction outlet located adjacent the first lateral flow strip;
a second well configured to receive the second volume of the sample from the sample receiving zone, the second well comprising a second flow restriction outlet located adjacent the second lateral flow strip;
wherein the lateral flow device comprises a pre-actuation configuration and an actuated configuration,
wherein the first and second flow restriction outlets are configured such that, in use, in the pre-actuation configuration, a first surface tension of the first volume of the sample within the first well prevents the first volume of the sample passing through the first flow restriction outlet and a second surface tension of the second volume of the sample within the second well prevents the second volume of the sample passing through the second flow restriction outlet; and
wherein, in the actuated configuration, (a) the first flow restriction outlet is located sufficiently proximate the first lateral flow strip such that the first volume of the sample makes contact with the first lateral flow strip and is drawn along the first lateral flow strip thereby overcoming the first surface tension; and (b) the second flow restriction outlet is located sufficiently proximate the second lateral flow strip such that the second volume of the sample makes contact with the second lateral flow strip and is drawn along the second lateral flow strip thereby overcoming the second surface tension.

In this way, a single volume of sample may be deposited in a sample receiving zone and distributed into different first and second volumes for delivery of the first and second volumes, respectively, to first and second lateral flow strips. As such, the first and second lateral flow strips may each receive a reliable but different volume of solution as required by first and second assays, respectively.

Furthermore, substantially all of the first and second volumes may arrive at the first and second lateral flow strips simultaneously, or at least within a short time window. This may be useful for timed tests, for example. Also, by ensuring that the tests are performed simultaneously, it minimises a possibility that the tests are performed in different ambient conditions. It may also be useful for ensuring that both tests take place under the same ambient conditions (e.g. the same temperature and pressure).

Moreover, a receiving area of the first lateral flow strip that sits adjacent to the first flow restriction outlet may receive an even distribution of the first volume of solution rather than, for example, receiving a greater proportion of sample centrally. Similarly, for the same reasons, a receiving area of the second lateral flow strip that sits adjacent to the second flow restriction outlet may receive an even distribution of the second volume of solution rather than, for example, receiving a greater proportion of sample centrally.

In a second aspect of the disclosure, there is provided a lateral flow device for analysing a sample of liquid, the lateral flow device comprising:
a lateral flow strip configured to respond to a test volume of the sample;
a well configured to receive a test volume of the sample, the well comprising a flow restriction outlet located adjacent the lateral flow strip and configured such that, in use, a surface tension of the test volume within the well prevents the test volume passing through the flow restriction outlet;
wherein the flow restriction outlet comprises an array of apertures, wherein each aperture in the array of apertures comprises an area of between 0.5 mm² and 1.2 mm².

In this way, it may be possible to provide to the lateral flow strip a specific test volume of sample. In addition, substantially all of the test volume may arrive at the lateral flow strip simultaneously, or at least within a short time window. This may be useful for timed tests, for example.

Moreover, a receiving area of the lateral flow strip that sits adjacent to the flow restriction outlet may receive an even distribution of the test volume of solution rather than, for example, receiving a disproportionate fraction of test volume centrally.

### BRIEF DESCRIPTION OF THE DRAWINGS

Embodiments of the disclosure will now be described, by way of example only, with reference to the accompanying drawings in which:

FIG. 1 shows a first embodiment of a lateral flow device in accordance with the first aspect of the disclosure;

FIG. 2 shows the first embodiment shown in FIG. 1, with a cover removed to reveal some of the internal components;

FIG. 3 shows a further view of a portion of the device of the first embodiment;

FIG. 4 shows a lower portion of the lateral flow device of the first embodiment;

FIG. 5 shows an alternative representation of the portion shown in FIG. 3, with an enlarged view of the flow restriction outlet comprising a grille;

FIG. 6 shows a second embodiment of a lateral flow device in accordance with the first aspect of the disclosure;

FIG. 7 shows the second embodiment shown in FIG. 6, with a cover removed to reveal some of the internal components;

FIG. 8 shows an upper portion of the device of the second embodiment;

FIG. 9 shows a lower portion of the device of the second embodiment; and

FIG. 10 shows an exploded view of the device of the second embodiment.

### DETAILED DESCRIPTION

### First Embodiment of a Lateral Flow Device in Accordance with the First Aspect of the Disclosure

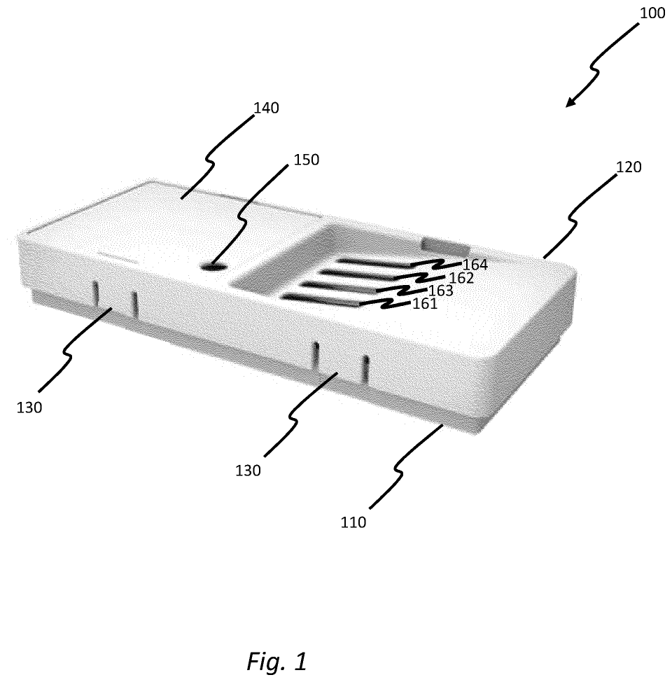

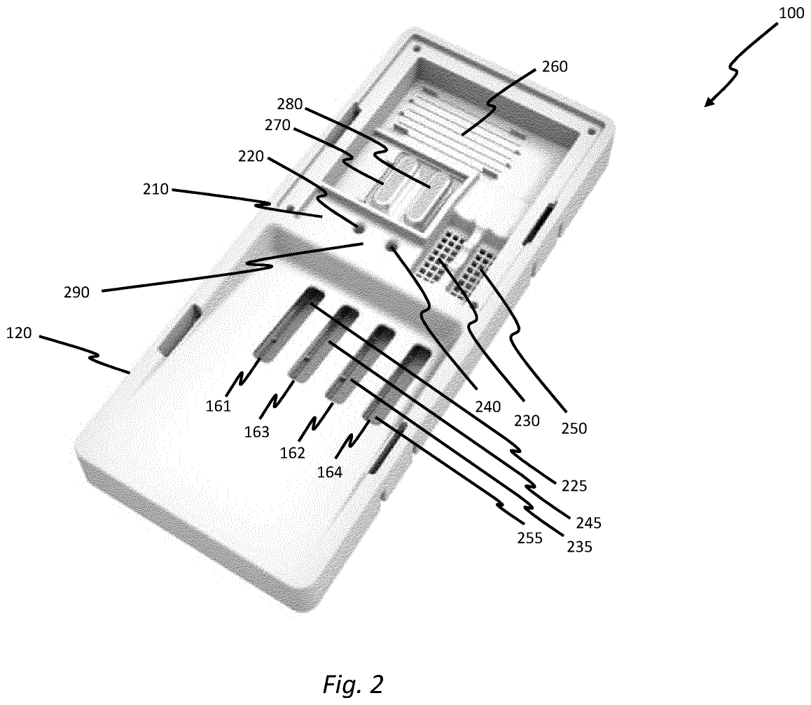

A first embodiment of a device 100 in accordance with the first aspect of the disclosure is shown in FIG. 1, which shows an exterior of the device 100. As shown in FIG. 2, the device 100 of the first embodiment comprises a first lateral flow strip 225, a second lateral flow strip 245, a third lateral flow strip 235 and a fourth lateral flow strip 255.

The device 100 comprises a lower portion 110 and an upper portion 120. The device 100 has a pre-actuation configuration and an actuated configuration. In the pre-actuation configuration, a lower part of the lower portion 110 protrudes beneath the upper portion 120 as shown in FIG. 1. In the actuated configuration, the upper portion 120 is positioned such that less (or none) of the lower portion 110 protrudes beneath the upper portion 120.

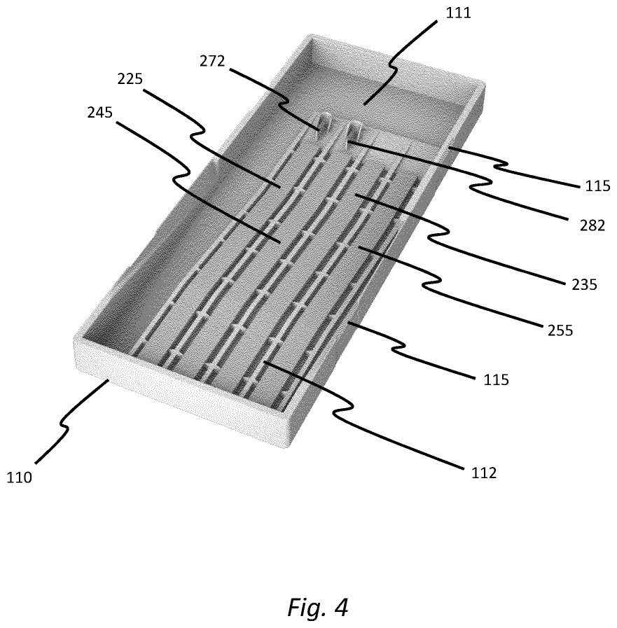

The upper portion 120 comprises ribs 130 that are configured to flex outwardly in response to the application of a force applied to the upper portion 120 relative to the lower portion 110. The lower portion 110 comprises protrusions 115 (visible in FIG. 4) configured to cooperate with the ribs 130. In the pre-actuation configuration, the ribs 130 abut the protrusions 115 so as to retain the device 100 in the pre-actuation configuration. On application of sufficient force, the ribs 130 ride over the protrusions 115 such that the device transitions to the actuated configuration. Aspects of operation of the device 100 are discussed further below.

The upper portion 120 further comprises a cover 140 having a sample deposition port 150 through which a liquid sample may be deposited into an interior of the device 100. The device 100 further comprises first, second, third and fourth windows 161, 162, 163, 164, corresponding to first, second, third and fourth lateral flow strips. A test region of each lateral flow strip 225, 245, 235, 255 may be visible through its respective window 161, 163, 162, 164.

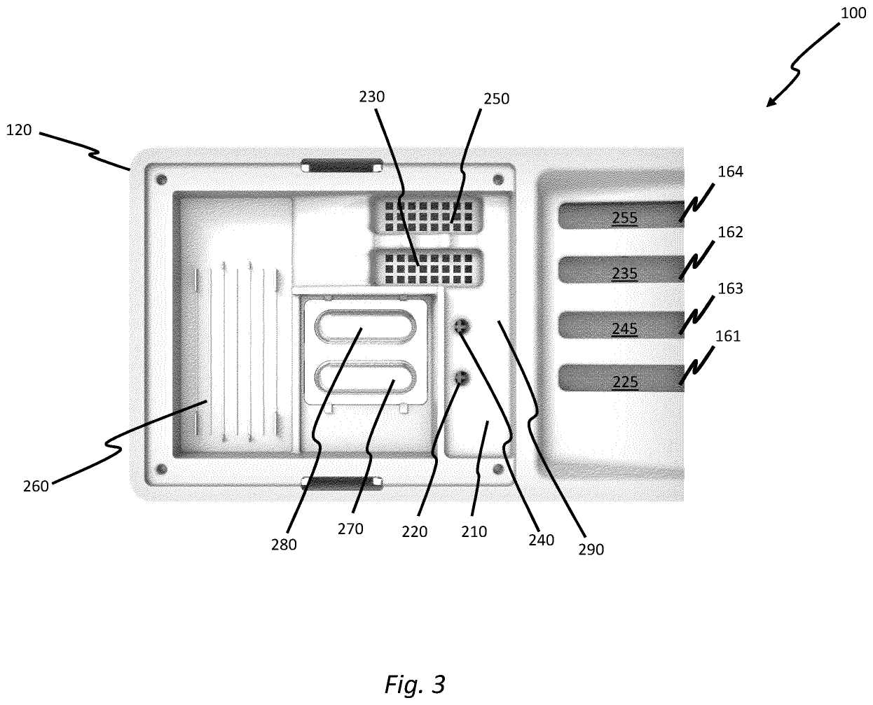

FIG. 2 shows the first embodiment of the device 100 with the cover 140 removed. FIG. 3 shows part of the embodiment of FIG. 2 enlarged and in plan rather than perspective view. The device 100 comprises a sample receiving zone 210 for receiving the sample to be analysed. The sample receiving zone 210 is located beneath the sample deposition port 150 of the cover 140 (not shown in FIG. 2).

The device 100 comprises a flow path 290 that extends between the sample receiving zone 210 (at an upstream end of the flow path 290) and a sink region 260 (at a downstream end of the flow path 290) which may, optionally, contain an absorbent pad 261.

A first well 220, a second well 230, a third well 240 and a fourth well 250 are located along the flow path 290. The first well 220 is located adjacent and corresponds with the first lateral flow strip 225, the second well 230 is located adjacent and corresponds with the second lateral flow strip 235, the third well 240 is located adjacent and corresponds with the third lateral flow strip 245 and the fourth well 250 is located adjacent and corresponds with the fourth lateral flow strip 255. The first well 220 and the third well 240 are each of a first volume. The second well 230 and the fourth well 250 are each of a second volume, wherein the second volume is greater than the first volume.

Each of the first well 220, the second well 230, the third well 240 and the fourth well 250 is defined in part by one or more side walls. In the case of each of the first well 220 and the third well 240, the well is cylindrical and comprises a single cylindrical side wall. In the case of each of the second well 230 and the fourth well 250, the well is rectangular and each of the second well 230 and the fourth well 250 comprises four side walls.

A base of each of the first well 220, the second well 230, the third well 240 and the fourth well 250 comprises a flow restriction outlet that comprises a grille. Each grille has a plurality of barrier portions between which are a plurality of apertures. Grille architecture is discussed in further detail below.

The device 100 further comprises a first buffer capsule 270 and a second buffer capsule 280. The first buffer capsule 270 is associated with the first lateral flow strip 225 and the second buffer capsule 280 is associated with the third lateral flow strip 245.

The first and third lateral flow strips 225, 245, which correspond with the (relatively smaller) first and third wells 220, 240, may require a smaller volume of sample than the second and fourth lateral flow strips 235, 255, which correspond with the (relatively larger) second and fourth wells 230, 250. The first and second buffer capsules 270, 280 may each provide a volume of buffer solution to their respective first and third lateral flow strips 225, 245 in which buffer solution the sample supplied via the first and third wells 220, 240 may be diluted.

The first and second buffer capsules 270, 280 may each comprise a blister portion (not shown) on an underside of each of the first and second buffer capsules 270, 280. Referring to FIG. 4, an upper face 111 of the lower portion 110, facing the underside of the first buffer capsule 270 may comprise a first piercing element 272 adjacent to the blister portion of the first buffer capsule 270. Similarly, the upper face 111 of the lower portion 110, facing the underside of the second buffer capsule 280 may comprise a second piercing element 282 adjacent to the blister portion of the second buffer capsule 280.

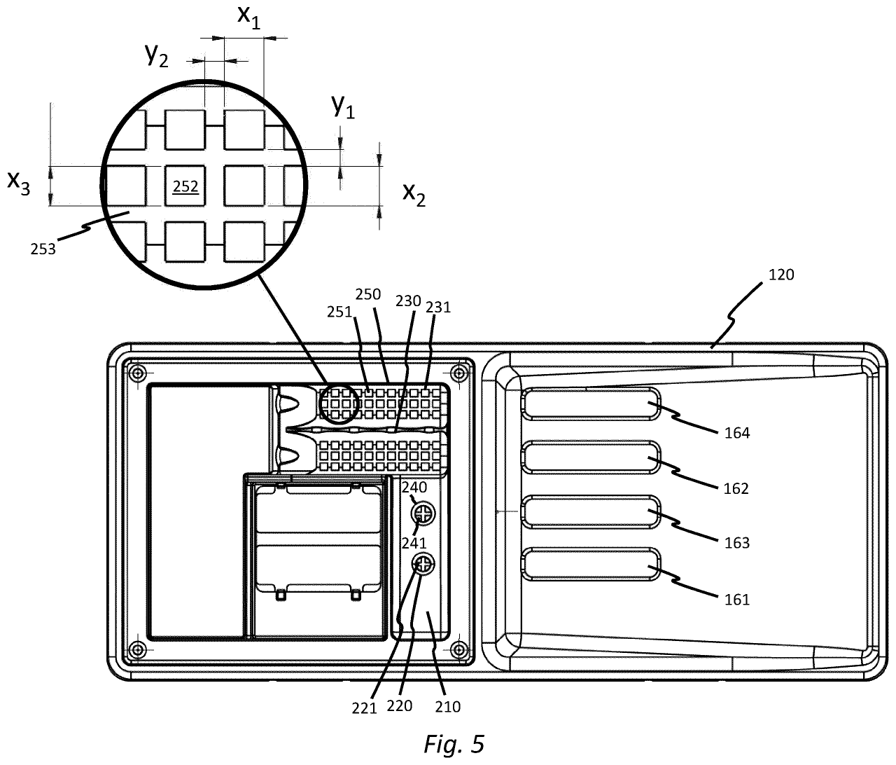

FIG. 4 shows almost the full length of each of the first, second, third and fourth lateral flow strips 225, 245, 235, 255. As shown, each of the first, second, third and fourth lateral flow strips 225, 245, 235, 255 may be mutually parallel. Also, each of the first, second, third and fourth lateral flow strips 225, 245, 235, 255 may sit on a frame structure 112 that projects above the upper face 111 of the lower portion 110. The frame structure 112 may be such that each of the first, second, third and fourth lateral flow strips 225, 245, 235, 255 rises gradually away from the upper face 111 of the lower portion 110 with distance away from the first well 220, the second well 230, the third well 240 and the fourth well 250. In this way, the liquid may be drawn along each lateral flow strip against the effect of gravity. This may regulate the speed at which the liquid is drawn along each lateral flow strip. FIG. 5 shows an enlarged representation of a part of the fourth well 250 comprising a part of the fourth flow restriction outlet 251. The fourth flow restriction outlet 251 comprises a plurality of flow restriction apertures 252 defined by gaps between a network of mesh 253.

Each flow restriction aperture 252 may be defined by its width (x₁) and its length (x₂) at a top face of the mesh 253. In some embodiments x₁=x₂. The width (x₄—not shown) and length (x₃) of each aperture 252 at a bottom face of the mesh 253 may be smaller than at the top face of the mesh such that x₃<x₁ and x₄<x₂.

In a particular embodiment, x₁=x₂=1.00 mm and x₃=x₄=0.75 mm.

Each flow restriction aperture 252 may be separated from each adjacent flow restriction aperture 252 by the mesh 253. The mesh may have portions that are parallel to the lateral flow strip 255 and portions that are perpendicular to the lateral flow strip 255. The portions of the mesh that are parallel to the lateral flow strip may have a first width, y₁, while the portions of the mesh that are perpendicular to the lateral flow strip may have a width second, y₂. In some embodiments y₁=y₂. In other embodiments y₂>y₁.

In a particular embodiment, y₁=0.42 mm and y₂=0.50 mm.

In a similar way to how each flow restriction aperture 252 may have a larger area at the top of the flow restriction aperture 252 than at the bottom of the flow restriction aperture 252, it may be also that the fourth well 250 may have a larger area at the top of the well 250 than at the bottom of the well 250.

While the details of the flow restriction aperture 252 have been explained and illustrated with reference to the fourth well 250, it may be that exactly the same applies to the second flow restriction aperture 230.

Since the first and third wells 220, 240 are smaller than the second and fourth wells 230, 250, there may be other consequential differences as well as unrelated differences. In particular, while the shape of the second and fourth wells 230, 250 is generally rectangular when viewed in plan view, the shape of the first and third wells 220, 240 is generally circular when viewed in plan view. Accordingly, the circular perimeter may not be able to accommodate whole square apertures, as shown in FIG. 5. In particular, while the shape of each aperture of the first and third wells 220, 240 may be defined in part by the mesh in a similar fashion to the second and fourth wells 230, 250, the shape of each aperture of the first and third wells, 220, 240 may be defined in part by a portion of a circular interior surface of the first and third wells 220, 240.

In use, a liquid sample is deposited through the sample deposition port 150 (shown in FIG. 1) such that it is received into the sample receiving zone 210 (shown in FIG. 2). The sample receiving zone 210 represents the start of the flow path 290. As sample is deposited through the sample deposition port 150 onto the sample receiving zone 210, it travels along the flow path 290 due to a modest gradient. Walls of the flow path 290 prevent flow of sample other than along the flow path 290.

As a front of the liquid sample reaches the first well 220, some of the sample falls into the first well 220 until the first well 220 is full of sample. Thus a first volume of sample is present in the first well 220. The first volume of sample does not pass through the first flow restriction outlet 221 due to surface tension in the liquid preventing passage of the first volume through the first flow restriction outlet 221.

As the front of the liquid sample reaches the third well 240, some of the sample falls into the third well 240 until the third well 240 is full of sample. Thus a third volume of sample is present in the third well 240. The third volume of sample does not pass through the third flow restriction outlet 241 due to surface tension in the liquid preventing passage of the third volume through the third flow restriction outlet 241.

In the embodiment of FIG. 1, the first and third volumes are equal because the first and third wells 220, 240 have equal volumes.

As the front of the liquid sample reaches the second well 230, some of the sample falls into the second well 230 until the second well 230 is full of sample. Thus a second volume of sample is present in the second well 230. The second volume of sample does not pass through the second flow restriction outlet 231 due to surface tension in the liquid preventing passage of the second volume through the second flow restriction outlet 231.

As the front of the liquid sample reaches the fourth well 250, some of the sample falls into the fourth well 250 until the fourth well 250 is full of sample. Thus a fourth volume of sample is present in the fourth well 250. The fourth volume of sample does not pass through the fourth flow restriction outlet 251 due to surface tension in the liquid preventing passage of the fourth volume through the fourth flow restriction outlet 251.

In the embodiment of FIG. 1, the second and fourth volumes are equal because the second and fourth volumes 230, 250 have equal volumes.

As the front of the liquid sample reaches the sink region 260, it is drawn into the sink region 260 which may include an absorbent material (not shown). The absorbent material may assist in accelerating flow of sample along the flow path 290.

Once the liquid sample has distributed through the flow path 290 such that all of the first, second, third and fourth wells contain their full volume of sample, the lateral flow device 100 is ready for actuation.

Actuation from the pre-actuation configuration to the actuated configuration involves applying a force to the upper portion 120 such that it moves towards the lower portion 110. On application of sufficient force, the ribs 130 of the upper portion 120 ride over the protrusions 115 of the lower portion 110 such that the upper portion 120 moves towards the lower portion 110 to transition from the pre-actuation configuration to the actuated configuration. As a consequence of this movement, the first, second, third and fourth flow restriction outlets 221, 231, 241, 251 move towards their respective lateral flow strips such that an underside of each flow restriction outlet 221, 231, 241, 251 is sufficiently close to its respective lateral flow strip 225, 235, 245, 255 that liquid is drawn onto the lateral flow strip sufficient, overcoming the surface tension that prevents the liquid samples passing through the first, second, third and fourth flow restriction outlets 221, 231, 241, 251 when in the pre-actuation configuration. In this way, the first, second, third and fourth volumes arrive on the first, second, third and fourth lateral flow strips 225, 235, 245, 255, respectively. Moreover, the first, second, third and fourth volumes arrive evenly on their respective lateral flow strips across the full area of their respective flow restriction outlets. Moreover, the first, second, third and fourth volumes may arrive on their respective lateral flow strips substantially simultaneously.

As a second consequence of the movement of the upper portion 120 towards the lower portion 110 in moving from the pre-actuation configuration to the actuated configuration, the first and second buffer capsules 270, 280 are actuated piercing of the blister portion of each of the first and second buffer capsules 270, 280 by their respective piercing elements. As such, the buffer solution contained within each of the first and second buffer capsules 270, 280 is received onto the first and third lateral flow strips 225, 245, respectively, in a location on the first and third lateral flow strips 225, 245 that is upstream of the first and third wells 220, 240. In this way, buffer solution is drawn down each of the first and third lateral flow strips 225, 245 towards the first and third volumes of solution that are deposited on the first and third lateral flow strips 225, 245 and thereby dilute those first and third volumes of solution so as to facilitate/accelerate passage of the first and third volumes of the liquid sample down the first and third lateral flow strips 225, 245 towards test regions on those first and third lateral flow strips 225, 245.

### Worked Example of a Specific Arrangement of the First Embodiment

A worked example is now discussed with reference to the first embodiment of a lateral flow device in accordance with the first aspect of the disclosure, as shown in FIGS. 1 to 5.

In the specific arrangement of the first embodiment, the first volume (that being the volume of the first well 220) is 20 μl. The third volume (that being the volume of the third well 240) is also 20 μl.

In the specific arrangement of the first embodiment, the second volume (that being the volume of the second well 230) is 250 μl. The fourth volume (that being the volume of the fourth well 250) is also 250 μl.

In the specific arrangement of the first embodiment, each of the first buffer capsule 270 and the second buffer capsule 280 may hold a volume of buffer solution of approximately 180 μl.

In the specific arrangement of the first embodiment, x₁=x₂=1.00 mm and x₃=x₄=0.75 mm. In the specific embodiment, y₁=0.42 mm and y₂=0.50 mm.

The lateral flow device of the specific arrangement of the first embodiment may be used for analysing a sample of human blood. The viscosity of human blood at 37° C. is normally in the range 3×10⁻³ Pa·s to 4×10⁻³ Pa·s.

A volume of blood of 20 μl or 250 μl (that is, either equal to the volume of the first well or equal to the volume of the second well) and having a viscosity within the range 3×10⁻³ to 4×10⁻³ Pa·s has been shown to have sufficient surface tension to prevent its passage under the force of gravity alone through the flow restriction apertures of the flow restriction outlets of the specific embodiment, wherein x₁=x₂=1.00 mm and x₃=x₄=0.75 mm.

As such, the blood remains in the wells until the device is actuated. On actuation, a force associated with actuation is sufficient to overcome the surface tension and actuate passage of the blood through the respective flow restriction apertures.

In the specific arrangement of the first embodiment, the buffer may comprise 1×phosphate buffered saline supplemented with 10 mg/mL bovine serum albumin and 0.1% Tween20 which has a viscosity at 37° C. of approximately 3×10⁻³ Pa·s.

It is known that viscosity and surface tension of blood may vary dependent upon factors including temperature as well as on underlying health conditions of the patient.

A test might be performed on blood taken directly from the body without significant delay, or there may be a delay in between the blood being taken from the body and the test being performed.

Blood taken directly from the human body may be expected to have a temperature of ˜37° C. but may potentially have a higher temperature of perhaps ˜39° C. in a patient with a fever. Regardless of the temperature of the blood within the body, in ambient conditions (20° C., for example), a sample of blood taken from the body will begin to cool almost immediately, especially when a small volume of blood is taken in isolation. Therefore, even when blood is taken for an almost immediate test, it is expected to have cooled at least somewhat before the specific arrangement of the first embodiment is actuated.

It is considered that operation of the specific arrangement of the first embodiment would be suitable for a wide range of blood samples at temperatures of between 15° C. and 39° C. The specific embodiment has been shown extensively to operate successfully with blood samples at temperatures of between 18° C. and 28° C. and from patients with a range of underlying health conditions.

As set out in “Surface Tension of Blood”, E. HRNČÍŘ and J. ROSINA, Physiol. Res. 46:319-321, 1997 indicates that in a sample of 71 healthy subjects, the surface tension of blood at 22° C. was shown to be 55.89×10⁻³ N·m⁻¹, with a S.D.=3.57×10⁻³ N·m⁻¹ when measured using the drop method set out by HAVRÁNEK A. in 1967: Surface tension (in Czech). In: Basis of Physical Measurements (in Czech). J. BROŽ (ed.), Státnípedagogické nakladatelstvi, Prague, 1967, pp. 141-143.

“The Surface Tension of Blood Serum, and the Determination of the Surface Tension of Biological Fluids”, HENRY N. HARK-INS and WILLIAM D. HARKINS, THE JOURNAL OF CLINICAL INVESTIGATION, VOL. vii, NO. 2, Jan. 4, 1929 indicates that surface tension of blood serum at 20C.° may be in the region of 52 dynes per centimetre (52×10⁻³ N·m⁻¹) and at 37° C. may be in the region of 48 dynes per centimetre (48×10⁻³ N·m⁻¹).

Accordingly, the specific arrangement of the first embodiment is expected to be suitable for use with blood having a temperature of between 15° C. and 39° C. and having a surface tension within the range 48×10⁻³ N·m⁻¹ and 60×10⁻³ N·m⁻¹.

The worked example here is not intended to suggest that the lateral flow device in accordance with the disclosure is limited to any particular sample type. It is sufficient simply that the sample is prevented from passing through the flow restriction apertures until actuated.

While the worked example relates to blood, the specific arrangement of the first embodiment may also be appropriate for analysis of serum, plasma or urine. It has been shown that the specific embodiment has the same effect of providing surface tension to prevent passage of other liquid samples through the flow restriction apertures, including aqueous samples, which may have a lower viscosity than that of blood. It has also been shown that blood that is more viscous than average human blood is appropriate for use with the specific embodiment.

Neither the disclosure nor the first embodiment of the disclosure is limited to the aperture sizes of the specific arrangement of the first embodiment. For example, each of the first and second flow restriction apertures may have an area of between 0.75 mm² and 1.25 mm². A width of each portion of the first grille that defines a spacing between adjacent first flow restriction apertures may be between 0.3 mm and 0.6 mm, and preferably between 0.42 mm and 0.50 mm.

### Second Embodiment of a Lateral Flow Device in Accordance with the First Aspect of the Disclosure

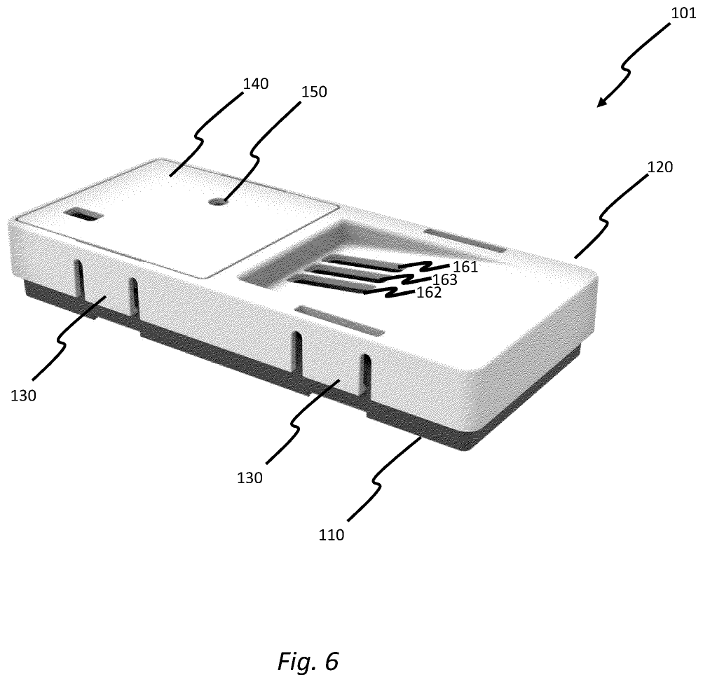

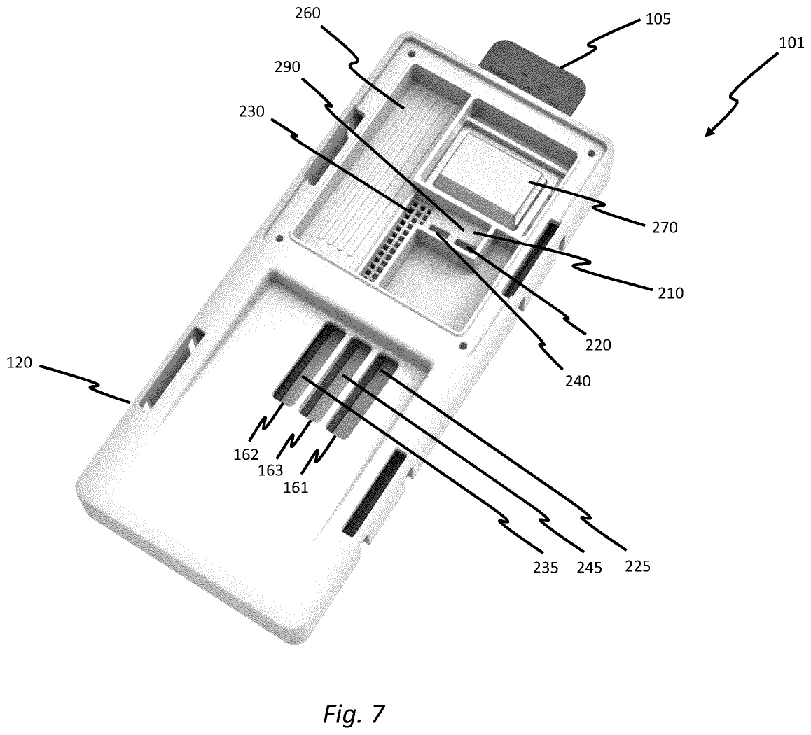

A second embodiment of a device 101 in accordance with the first aspect of the disclosure is shown in FIG. 6, which shows an exterior of the device 101. As shown in FIG. 7, the device 101 of the first embodiment comprises a first lateral flow strip 225, a second lateral flow strip 245, and a third lateral flow strip 235.

The device 101 comprises a lower portion 110 and an upper portion 120. The device 101 has a pre-actuation configuration and an actuated configuration. In the pre-actuation configuration, a lower part of the lower portion 110 protrudes beneath the upper portion 120 as shown in FIG. 6. In the actuated configuration, the upper portion 120 is positioned such that less (or none) of the lower portion 110 protrudes beneath the upper portion 120.

The lower portion 110 comprises a tab 105 that prevents the device from transitioning out of the pre-actuation configuration and into the actuated configuration. The tab 105 is removable (e.g. it can be snapped off) in order to facilitate movement of the device from the pre-actuation configuration and an actuated configuration by application of a force between the upper portion 120 and the lower portion 110.

The upper portion 120 comprises ribs 130 that are configured to flex outwardly in response to the application of a force applied to the upper portion 120 relative to the lower portion 110. The lower portion 110 comprises protrusions 115 configured to cooperate with the ribs 130. In the pre-actuation configuration, the ribs 130 abut the protrusions 115 so as to retain the device 101 in the pre-actuation configuration. On application of sufficient force, the ribs 130 ride over the protrusions 115 such that the device transitions to the actuated configuration. Aspects of operation of the device 101 are discussed further below.

The upper portion 120 further comprises a cover 140 having a sample deposition port 150 through which a liquid sample may be deposited into an interior of the device 101. The device 101 further comprises first, second and third windows 161, 162, 163, corresponding to first, second and third lateral flow strips 225, 245, 235. A test region of each lateral flow strip 225, 245, 235 may be visible through its respective window 161, 163, 162.

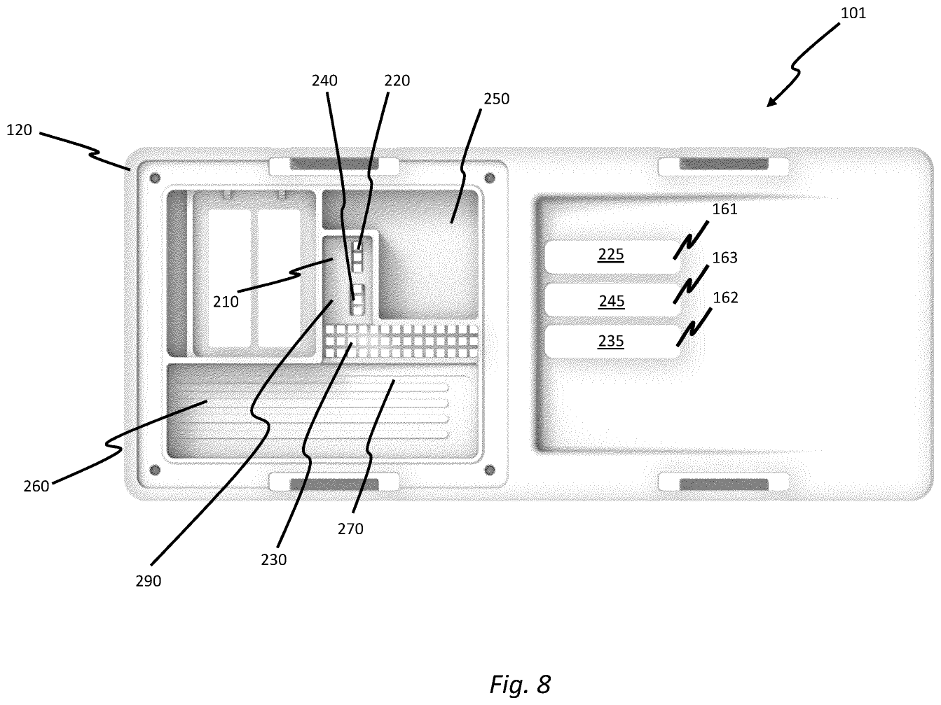

FIG. 7 shows the second embodiment of the device 101 with the cover 140 removed. FIG. 8 shows the upper portion 120 of the second embodiment in plan view. The device 101 comprises a sample receiving zone 210 for receiving the sample to be analysed. The sample receiving zone 210 is located beneath the sample deposition port 150 of the cover 140 (not shown in FIG. 7).

The device 101 comprises a flow path 290 that extends between the sample receiving zone 210 (at an upstream end of the flow path 290) and a sink region 260 (at a downstream end of the flow path 290).

A first well 220, a second well 230 and a third well 240 are located along the flow path 290. The first well 220 is located adjacent and corresponds with the first lateral flow strip 225, the second well 230 is located adjacent and corresponds with the second lateral flow strip 235 and the third well 240 is located adjacent and corresponds with the third lateral flow strip 245. The first well 220 and the third well 240 are each of a first volume. The second well 230 is of a second volume, wherein the second volume is greater than the first volume.

Each of the first well 220, the second well 230 and the third well 240 is defined in part by one or more side walls. In the second embodiment shown in FIG. 8, each of the first well 220, the second well 230 and the third well 240 is rectangular and comprises four side walls.

A base of each of the first well 220, the second well 230 and the third well 240 comprises a flow restriction outlet that comprises a grille. Each grille has a plurality of barrier portions between which are a plurality of apertures. Grille architecture is discussed in further detail below.

The device 101 further comprises a buffer capsule 270. The buffer capsule 270 is associated with the first lateral flow strip 225 and the third lateral flow strip 245.

The first and third lateral flow strips 225, 245, which correspond with the (relatively smaller) first and third wells 220, 240, may require a smaller volume of sample than the second lateral flow strip 235, which corresponds with the (relatively larger) second well 230. The buffer capsule 270 may provide a volume of buffer solution to the first and third lateral flow strips 225, 245 in which buffer solution the sample supplied via the first and third wells 220, 240 may be diluted.

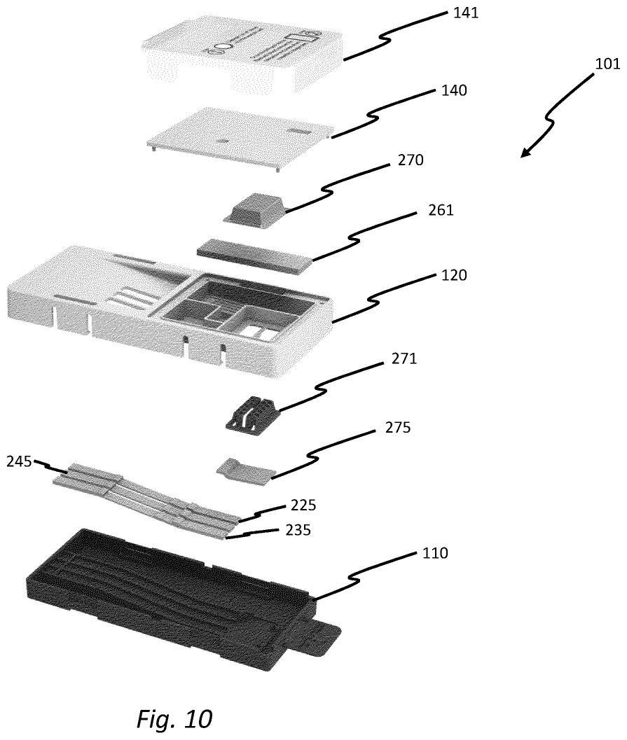

The buffer capsule 270 may comprise a blister portion (not shown) on an underside of the buffer capsule 270. Referring to FIG. 10, the device 101 may comprise a piercing element 271 located between the buffer capsule 270 and the first and third lateral flow strips 225, 245. The device 101 may further comprise a buffer pad 275 between the piercing element 271 and the first and third lateral flow strips 225, 245. The buffer pad 275 may regulate flow of buffer between the buffer capsule 270 and the first and third lateral flow strips 225, 245.

The piercing element 271 may comprise a pair of piercing regions, each one of the pair aligned with one of the first and third lateral flow strips 225, 245. Each piercing region may comprise a surface which sits parallel to the blister portion and which comprises apertures through which the buffer solution may flow once the piercing region has pierced the blister portion.

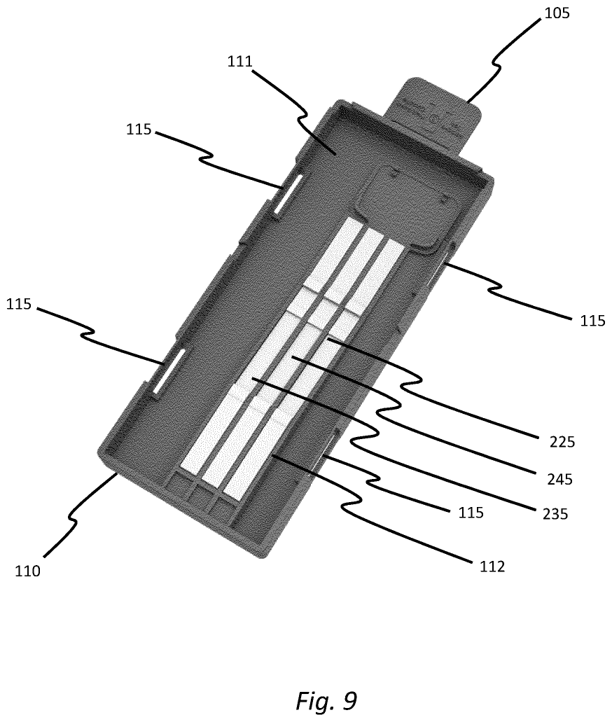

FIG. 9 shows the full length of each of the first, second and third lateral flow strips 225, 245, 235. As shown, each of the first, second and third lateral flow strips 225, 245, 235 may be mutually parallel. Also, each of the first, second and third lateral flow strips 225, 245, 235 may sit on a frame structure 112 that projects above the upper face 111 of the lower portion 110. The frame structure 112 may be such that each of the first, second and third lateral flow strips 225, 245, 235 rises gradually away from the upper face 111 of the lower portion 110 with distance away from the first well 220, the second well 230 and the third well 240. In this way, the liquid may be drawn along each lateral flow strip against the effect of gravity. This may regulate the speed at which the liquid is drawn along each lateral flow strip.

The flow restriction function of the second embodiment may be provided in the same manner as in the first embodiment using flow restriction outlets comprising a plurality of flow restriction apertures defined by gaps between a network of mesh.

Each flow restriction aperture may be defined by its width (x₁) and its length (x₂) at a top face of the mesh. In some embodiments x₁=x₂. The width (x₄—not shown) and length (x₃) of each aperture at a bottom face of the mesh may be smaller than at the top face of the mesh such that x₃<x₁ and x₄<x₂.

In a particular embodiment, x₁=x₂=1.00 mm and x₃=x₄=0.75 mm.

Each flow restriction aperture may be separated from each adjacent flow restriction aperture by the mesh. The mesh may have portions that are parallel to the lateral flow strip and portions that are perpendicular to the lateral flow strip. The portions of the mesh that are parallel to the lateral flow strip may have a first width, y₁, while the portions of the mesh that are perpendicular to the lateral flow strip may have a width second, y₂. In some embodiments y₁=y₂. In other embodiments y₂>y₁.

In a particular embodiment, y₁=0.42 mm and y₂=0.50 mm.

In a similar way to how each flow restriction aperture may have a larger area at the top of the flow restriction aperture than at the bottom of the flow restriction aperture, it may be also that each well may have a larger area at the top of the well than at the bottom of the well.

Since the first and third wells 220, 240 are smaller than the second wells 230, there may be other consequential differences as well as unrelated differences.

In use, a liquid sample is deposited through the sample deposition port 150 (shown in FIG. 6) such that it is received into the sample receiving zone 210 (shown in FIG. 7). The sample receiving zone 210 represents the start of the flow path 290. As sample is deposited through the sample deposition port 150 onto the sample receiving zone 210, it travels along the flow path 290 due to a modest gradient. Walls of the flow path 290 prevent flow of sample other than along the flow path 290.

As a front of the liquid sample reaches the first well 220, some of the sample falls into the first well 220 until the first well 220 is full of sample. Thus, a first volume of sample is present in the first well 220. The first volume of sample does not pass through the first flow restriction outlet 221 due to surface tension in the liquid preventing passage of the first volume through the first flow restriction outlet 221.

As the front of the liquid sample reaches the third well 240, some of the sample falls into the third well 240 until the third well 240 is full of sample. Thus, a third volume of sample is present in the third well 240. The third volume of sample does not pass through the third flow restriction outlet 241 due to surface tension in the liquid preventing passage of the third volume through the third flow restriction outlet 241.

In the embodiment of FIG. 6, the first and third volumes are equal because the first and third wells 220, 240 have equal volumes.

As the front of the liquid sample reaches the second well 230, some of the sample falls into the second well 230 until the second well 230 is full of sample. Thus, a second volume of sample is present in the second well 230. The second volume of sample does not pass through the second flow restriction outlet 231 due to surface tension in the liquid preventing passage of the second volume through the second flow restriction outlet 231.

As the front of the liquid sample reaches the sink region 260, it is drawn into the sink region 260 which may include an absorbent material (not shown). The absorbent material may assist in accelerating flow of sample along the flow path 290.

Once the liquid sample has distributed through the flow path 290 such that all of the first, third and second wells 220, 240, 230 contain their full volume of sample, the lateral flow device 101 is ready for actuation.

Actuation from the pre-actuation configuration to the actuated configuration involves applying a force to the upper portion 120 such that it moves towards the lower portion 110. On application of sufficient force, the ribs 130 of the upper portion 120 ride over the protrusions 115 of the lower portion 110 such that the upper portion 120 moves towards the lower portion 110, to transition from the pre-actuation configuration to the actuated configuration. As a first consequence of this movement, the underside of the cover 140 causes the liquid samples in each of the first, second and third wells 220, 230, 240 to push against the first, second and third flow restriction outlets 221, 231, 241 so as to overcome surface tension that prevents the liquid samples passing through the first, second and third flow restriction outlets 221, 231, 241. In this way, the first, second and third volumes arrive on the first, second and third lateral flow strips 225, 235, 245, respectively. Moreover, the first, second and third volumes arrive evenly on their respective lateral flow strips across the full area of their respective flow restriction outlets. Moreover, the first, second and third volumes may arrive on their respective lateral flow strips substantially simultaneously.

As a second consequence of the movement into the actuation configuration, the buffer capsule 270 is actuated by piercing of the blister portion by the piercing element 271. As such, the buffer solution contained within the buffer capsule 270 is received onto the buffer pad 275 before flowing first and third lateral flow strips 225, 245, respectively, in a location on the first and third lateral flow strips 225, 245 that is upstream of the first and third wells 220, 240. In this way, buffer solution is drawn down each of the first and third lateral flow strips 225, 245 towards the first and third volumes of solution that are deposited on the first and third lateral flow strips 225, 245 and thereby dilute those first and third volumes of solution so as to facilitate/accelerate passage of the first and third volumes of the liquid sample down the first and third lateral flow strips 225, 245 towards test regions on those first and third lateral flow strips 225, 245.

As evident from FIG. 10, the device 101 may further comprise a label 141 or print applied to the top cover 140 to provide instructions for use.

### Worked Example of a Specific Arrangement of the Second Embodiment

This worked example of the specific arrangement of the second embodiment may be the same as that for the specific arrangement of the first embodiment except as explicitly set out below.

In particular, in the specific arrangement of the second embodiment, the first volume (that being the volume of the first well 220) is 20 μl. The third volume (that being the volume of the third well 240) is also 20 μl.

In the specific arrangement of the second embodiment, the second volume (that being the volume of the second well 230) is 200 μl.

### Lateral Flow Device in Accordance with the Second Aspect of the Disclosure

While the illustrated lateral flow devices in accordance with the first and second embodiments of the first aspect of the disclosure comprise, respectively, four and three lateral flow strips, the disclosure is not so limited. Further, while a lateral flow device in accordance with the first aspect of the disclosure requires first and second lateral flow strips and respective first and second wells having different volumes, by contrast, in accordance with the second aspect of the disclosure, there is provided a lateral flow device comprising only a single lateral flow strip and a single well associated with the single lateral flow strip.

The single well of the embodiment of the second aspect of the disclosure may be the same as either the first well or the second well of the first or second embodiment of the first aspect of the disclosure, or it may have a different volume or aperture design and dimensions.

The single well may have a flow restriction outlet that comprises an array of apertures, wherein each aperture in the array of apertures comprises an area of between 0.5 mm² and 1.2 mm².

The flow restriction outlet may comprise a plurality of flow restriction apertures and a grille. The grille may comprises the plurality of flow restriction apertures arranged in an array.

Each flow restriction aperture may have an area of between 0.75 mm² and 1.25 mm².

Each of the plurality of flow restriction apertures may be equal in area to each of the other flow restriction apertures of the plurality of first flow restriction apertures.

Each flow restriction aperture may have an area of between 0.75 mm² and 1.25 mm².

Each flow restriction aperture may be spaced apart from each adjacent flow restriction aperture by a portion of the grille having a width of between 0.3 mm and 0.6 mm, and preferably between 0.42 mm and 0.50 mm.

The lateral flow device in accordance with the second aspect of the disclosure is not limited to any particular sample type. It is sufficient simply that the sample is prevented from passing through the flow restriction apertures until actuated.

The lateral flow device in accordance with the second aspect of the disclosure may also be appropriate for analysis of serum, plasma or urine.

It has been shown that the lateral flow device in accordance with the second aspect of the disclosure has the same effect of providing surface tension to prevent passage of other liquid samples through the flow restriction apertures, including aqueous samples, which may have a lower viscosity than that of blood. It has also been shown that blood that is more viscous than average human blood is appropriate for use with the lateral flow device in accordance with the second aspect of the disclosure.

1. A lateral flow device for analysing a sample of liquid, the lateral flow device comprising:
a sample receiving zone for receiving the sample to be analysed;
a first lateral flow strip configured to respond to a first volume of the sample;
a second lateral flow strip configured to respond to a second volume of the sample, wherein the second volume is greater than the first volume;
a first well configured to receive the first volume of the sample from the sample receiving zone, the first well comprising a first flow restriction outlet located adjacent the first lateral flow strip;
a second well configured to receive the second volume of the sample from the sample receiving zone, the second well comprising a second flow restriction outlet located adjacent the second lateral flow strip;
wherein the lateral flow device comprises a pre-actuation configuration and an actuated configuration,
wherein the first and second flow restriction outlets are configured such that, in use, in the pre-actuation configuration, a first surface tension of the first volume of the sample within the first well prevents the first volume of the sample passing through the first flow restriction outlet and a second surface tension of the second volume of the sample within the second well prevents the second volume of the sample passing through the second flow restriction outlet; and
wherein, in the actuated configuration, (a) the first flow restriction outlet is located sufficiently proximate the first lateral flow strip such that the first volume of the sample makes contact with the first lateral flow strip and is drawn along the first lateral flow strip thereby overcoming the first surface tension; and (b) the second flow restriction outlet is located sufficiently proximate the second lateral flow strip such that the second volume of the sample makes contact with the second lateral flow strip and is drawn along the second lateral flow strip thereby overcoming the second surface tension.

2. The lateral flow device of claim 1 further comprising a flow path extending between the sample receiving zone and a sink region, wherein the first and second wells are located in the flow path between the sample receiving zone and the sink region.

3. The lateral flow device of claim 1 or claim 2 wherein the lateral flow device further comprises a buffer capsule associated with the first lateral flow strip.

4. The lateral flow device of claim 3 wherein the actuation mechanism is further configured to actuate the buffer capsule such that a buffer solution in the buffer capsule is released onto the first lateral flow strip.

5. The lateral flow device of any preceding claim wherein the first flow restriction outlet comprises at least one first flow restriction aperture.

6. The lateral flow device of claim 5 wherein the first flow restriction outlet comprises a plurality of first flow restriction apertures.

7. The lateral flow device of claim 6 wherein each of the plurality of first flow restriction apertures is equal in area to each of the other first flow restriction apertures of the plurality of first flow restriction apertures.

8. The lateral flow device of claim 6 or claim 7 wherein the first flow restriction outlet comprises a first grille, wherein the first grille comprises the plurality of first flow restriction apertures arranged in a first array.

9. The lateral flow device of any of claims 6 to 8 wherein the second flow restriction outlet comprises a plurality of second flow restriction apertures.

10. The lateral flow device of claim 9 wherein each of the plurality of second flow restriction apertures is equal in area to each of the other second flow restriction apertures of the plurality of second flow restriction apertures.

11. The lateral flow device of claim 9 or claim 10 wherein the second flow restriction outlet comprises a second grille comprising the plurality of second flow restriction apertures arranged in a second array.

12. The lateral flow device of claim 10 or claim 11 wherein each of the first and second flow restriction apertures has an area of between 0.75 mm² and 1.25 mm².

13. The lateral flow device of claim 8 or any claim dependent on claim 8 wherein a width of each portion of the first grille that defines a spacing between adjacent first flow restriction apertures is between 0.3 mm and 0.6 mm, and preferably between 0.42 mm and 0.50 mm.

14. The lateral flow device of any preceding claim wherein the actuation mechanism comprises an actuation surface configured such that on actuation the actuation surface applies a force:
between the first flow restriction outlet and the first lateral flow strip; and
between the second flow restriction outlet and the second lateral flow strip.

15. The lateral flow device of claim 14 when dependent upon claim 4 wherein the actuation surface is further configured to effect actuation of the buffer capsule.

16. The lateral flow device of any preceding claim further comprising:
a third lateral flow strip configured to respond to a third volume of the sample; and
a third well configured to receive the third volume of the sample from the sample receiving zone, the third well comprising a third flow restriction outlet located adjacent the third lateral flow strip and configured such that a third surface tension of the third volume of the sample within the third well prevents the third volume of the sample passing through the third flow restriction outlet.

17. The lateral flow device of claim 16 wherein the third volume is equal to the first volume.

18. The lateral flow device of claim 16 or claim 17 further comprising:
a fourth lateral flow strip configured to respond to a fourth volume of the sample, wherein the fourth volume is equal to the first volume; and
a fourth well configured to receive the fourth volume of the sample from the sample receiving zone, the fourth well comprising a fourth flow restriction outlet located adjacent the fourth lateral flow strip and configured such that a fourth surface tension of the fourth volume of the sample within the fourth well prevents the fourth volume of the sample passing through the fourth flow restriction outlet.

19. The lateral flow device of claim 18 wherein the fourth volume is equal to the second volume.

20. The lateral flow device of any preceding claim further comprising a removable tab that is configured to prevent transition from the pre-actuation configuration to the actuated configuration until removal of the removable tab.

21. A lateral flow device for analysing a sample of liquid, the lateral flow device comprising:
a lateral flow strip configured to respond to a test volume of the sample;
a well configured to receive a test volume of the sample, the well comprising a flow restriction outlet located adjacent the lateral flow strip, the flow restriction outlet comprising an array of apertures, wherein each aperture in the array of apertures comprises an area of between 0.5 mm² and 1.2 mm²;
wherein the lateral flow device comprises a pre-actuation configuration and an actuated configuration;
wherein the flow restriction outlet is configured such that, in use, in the pre-actuation configuration, a surface tension of the test volume within the well prevents the test volume passing through the flow restriction outlet; and
wherein, in the actuated configuration, the flow restriction outlet is located sufficiently proximate the lateral flow strip such that the volume of sample makes contact with the lateral flow strip and is drawn along the lateral flow strip thereby overcoming the surface tension.

22. The lateral flow device of claim 21 wherein the flow restriction outlet comprises:
a grille;
wherein the grille comprises the plurality of flow restriction apertures arranged in an array.

23. The lateral flow device of claim 22 wherein each of the plurality of flow restriction apertures is equal in area to each of the other flow restriction apertures of the plurality of flow restriction apertures.

24. The lateral flow device of any of claims 21 to 23 wherein each flow restriction aperture has an area of between 0.75 mm² and 1.25 mm².

25. The lateral flow device of claim 22 or any claim dependent on claim 22 wherein each flow restriction aperture is spaced apart from each adjacent flow restriction aperture by a portion of the grille having a width of between 0.3 mm and 0.6 mm, and preferably between 0.42 mm and 0.50 mm.
